(19) United States
(12) Patent Application Publication
(10) Pub. No.: US 2004/0227342 A1
(43) Pub. Date: Nov. 18, 2004

(54) Album

(76) Inventor: Thomas Wasylik, Crystal, MN (US)

Correspondence Address: Angenehm Law Firm. Ltd., P.O. Box 48755, Coon Rapids, MN, 55448-0755, US

(21) Appl. No.: 10/844,221

(22) Filed: May 12, 2004

Related U.S. Application Data
(60) Provisional application No. 60/469,681, filed on May 12, 2003.

(51) Int. Cl. B42D 1/00

(52) U.S. Cl. 281/15.1

(57) ABSTRACT

An album, including a cover, the cover having a front and a back hingedly joined with a binding, the cover having an overlying coating; the cover being joined to corner protectors; a first platform joined to an inner surface of the cover, the first platform having an overlying coating; and a second platform joined to the first platform, the second platform having an overlying coating.

### FIELD OF THE INVENTION

The present invention relates to albums and more specifically to albums for displaying stamps and coins, claiming priority from provisional patent application No. 60/469,681, filed May 12, 2003, and entitled Album.

### BACKGROUND OF THE INVENTION

Stamp collectors have long enjoyed collecting first day covers. In the U.S. and many other countries, commemorative stamps are issued in one city that has particular relevance to the person, thing or event recorded on the stamp. For instance, a stamp of Abraham Lincoln, may issue the first day in Springfield, Ill. The following day, the commemorative stamp is available in all locations. First day covers are envelopes with the stamp canceled with a mark that commemorates the special day and event. The cancellation is only used on the first day of issuance. The envelopes themselves are often ornately decorated, with steel block scenes printed in the envelope, colored scenes and even gold replicas of the stamps in protective windows. It can therefore, be appreciated the first day covers are genuine collector items that can be worth immense amounts of money for rare and difficult to find stamps.

Collectable coins, while often sold and stored in plastic protective cases, have been placed into a new product. Coins have been placed in first day covers and envelopes structured similar to first day covers. That is, the coin is in a protective window on the left side of the envelope. These collectable coins, like their stamp counterpart are worth very substantial amounts of money as well.

Typically, a stamp album has a cover, often firm, that is encapsulated in a plastic outer layer. A ring or peg system is used to penetrate a flap portion of a polymeric holder which has a pocket portion adjacent the flap. The holders often tear out along the holes through which the pins extend. Moreover, such albums are rigid and provide no cushioning to the first day covers or like envelops inside.

Early first day covers, which had a printed picture in lieu of a protective window stored well in these prior art albums. With the advent of the rigid protective windows with leaf replicas of stamps and coins, the cover itself has been used to absorb the blows that the album encounters over time. Gravity, dropping of the album and other pressure placed on the unit causes the covers to dent, crease and otherwise sustain damage. Most would agree that these prior art albums are hardly an acceptable manner in which to store collectables that can be worth hundreds of thousands of dollars.

What is needed is an album for storing first day covers and like collectables that includes platforms with cushioning built into the platforms. The platforms should be sufficiently flexible to avoid denting and creasing of the covers. The holders should be secured in such a manner that the holders do not tears or otherwise become dislodged, especially along the flap area where most holder damage starts.

### SUMMARY OF THE INVENTION

The present invention is an album for storing first day covers and like collectables that includes platforms with cushioning built into the platforms. The platforms preferably are sufficiently flexible to avoid denting and creasing of the covers. The holders preferably are secured in such a manner that the holders do not tears or otherwise become dislodged, especially along the flap area where most holder damage starts.

The present album is provided with an a cover, a first platform, a second platform holders, and medallions securing the holders to the second platform. The cover may have a front and a back hingedly joined with a binding. The cover has an overlying coating and the cover may be joined to the cover with corner protectors.

The first platform may be joined to an inner surface of the cover. The first platform has an overlying coating.

The second platform may be joined to the first platform. The second platform may have an overlying coating.

Holders may be secured to the second platform. The holders preferably have a pocket hingedly joined to a flap. The pocket has walls defining an aperture. The flap can define apertures. Fasteners desirably extend through the apertures in the flap and secure to the second platform.

Medallions including holder medallions can be fastened to the second platform with the flap of the holders secured therebetween. The holder medallions desirably are in contact the majority of the surface area of the flap. The fasteners joining the holders to the second platform desirably pass through the medallion to firmly position the holder medallions against the flap.

Advantageously, the present invention provides platforms for supporting delicate collectables such as stamps, e.g. first day covers, and coins.

As a further advantage, the present invention provides multiple platforms in a stacked relationship, placing the fine collectables on a protective pedestal.

As yet a further advantage, medallions secure the fine collectables in a mechanically secure method, precluding tearing of the holders by spreading the securement force across a broad area.

These and other advantages will become apparent from reading the detailed description below with reference to the appended drawings.

### DESCRIPTION OF THE FIGURES

FIG. 1 is a prospective view showing the present invention in a display position on a stand;

FIG. 2 is a prospective view showing the present invention in a closed or storage position;

FIG. 3 is a prospective view showing a holder of the present invention; and

FIG. 4 is top view showing the present invention in a display position.

### DETAILED DESCRIPTION OF THE PRESENT INVENTION

The present inventive album 10 is designed to support, protect, and display collectibles such as first day covers in a manner providing easy access to information about the collectable. The Album 10 preferably includes a cover 12 selectively mountable on a stand 50 with holders 60 secured inside the cover 10 and strategically placed medallions 80 to disclose information. Each of the components will be discussed in serial fashion.

The cover 12 may include a shell 14, a first platform 28, a second platform 32 and ties 36. The shell 14 includes a front 16 and back 18 joined with a binding 20. The front 16, back 18 and binding 20 preferably are manufactured from a durable material such that they will not sag or bend when the cover 12 is placed on the stand 50 for extended periods of time. Disposed between the binding 20, the front 16 and/or back 18 may be hinges 22. Preferably such hinges a of the type commonly sold under the generic name of piano hinges.

The cover 12 may have an overlying coating 24 with decorative and protection functions. Coatings 24 may be one or more of various natural and synthetic fabrics or plastics. The most preferred coating 24 is velvet fabric or fabrics with similar cushioning characteristics wrapping about a foam padding, which is disposed about at least a portion of the cover 12. The coating may be of a wide variety of colors and should encase the exposed portions of the cover 12.

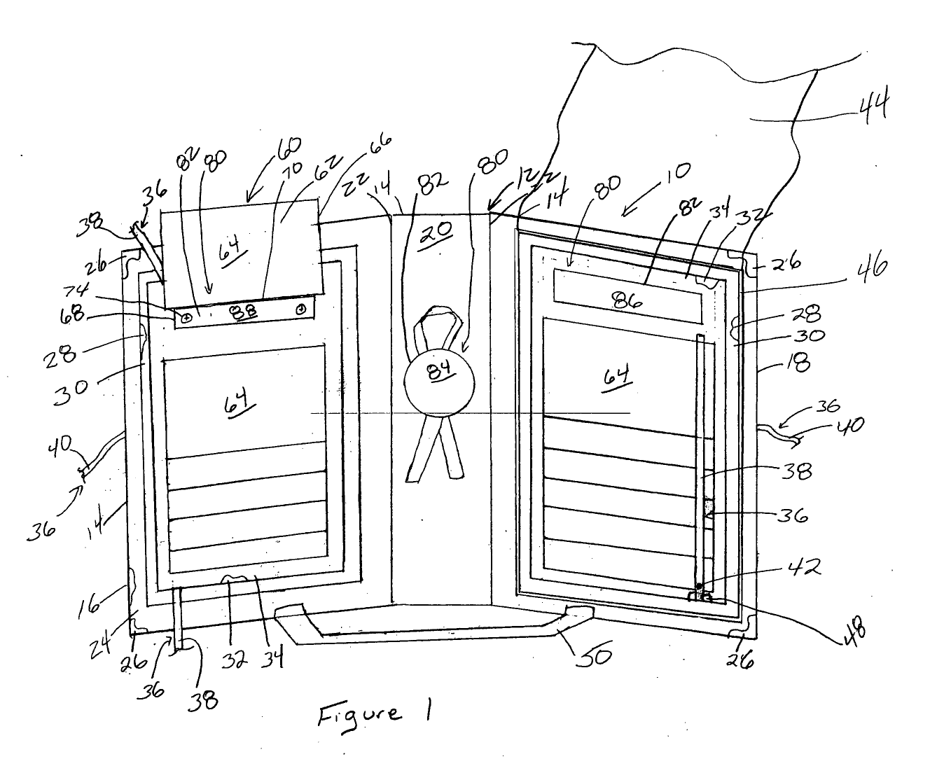

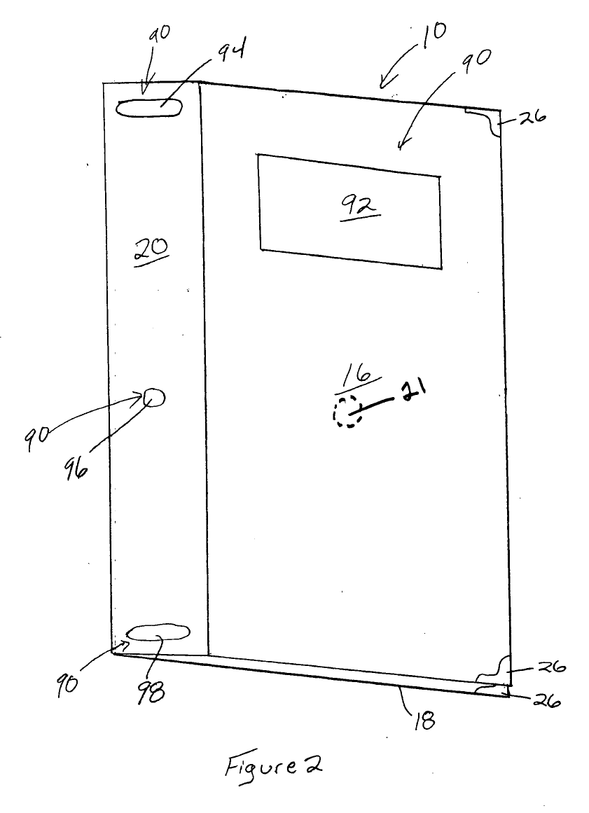

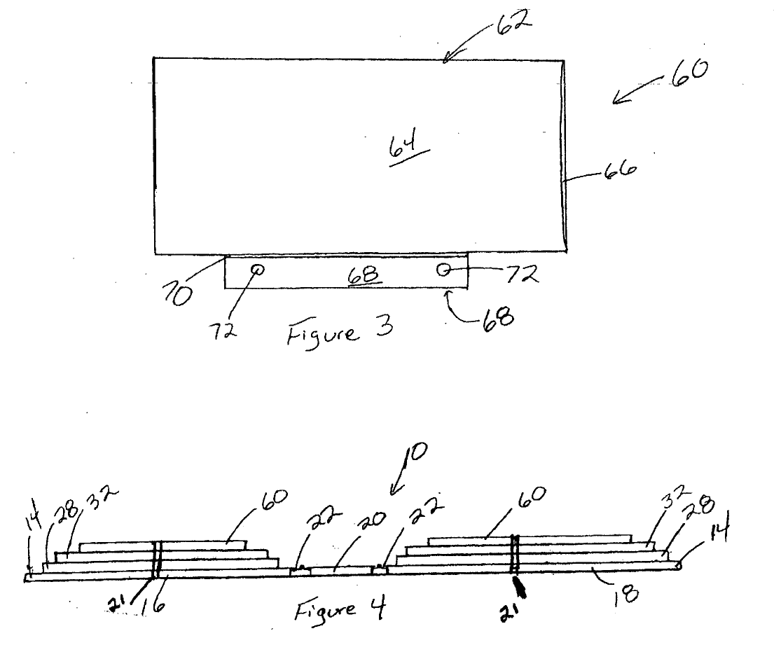

A first platform 28 may be secured inside the front 16 and back 18 portions of the cover 12. The first platform 28 is perhaps ⅛th to ½ inch in thickness and most preferably approximately ¼ inch in thickness. The first platform 28 may include padding of sufficient flexibility to absorb pressures on first day covers to avoid creasing or bending of the covers. The first platform 28 is generally sized smaller in length and width than the corresponding cover 12 as shown in FIG. 1. A coating 30 may be disposed about the first platform 28 in a manner similar to the coating 24 secured about the cover 12 with similar materials and construction. Preferably the color of coating 30 is different from the color of the coating 24.

A second platform 32 may be secured to the first platform 28. The second platform 32 is generally sized smaller in length and width than the corresponding first platform 28 as shown in FIG. 1, but similar in thickness. A coating 34 may be disposed about the second platform 32 in a manner similar to coatings 24, and 30 secured about the cover 12 and first platform 28 with similar materials and construction. Preferably the color of coating 34 is different from the color of the coatings 24 and 30. In a patriotic theme, the cover 12 may have a blue coating 24, the first platform 28 may have a white coating 30 and the second platform 32 may have a red coating 34. The second platform, ideally has a foam padding as part of the coating 34 as this aids in the preservation of the collectable, providing a uniform give to avoid undesirable bends or folds in the collectable. A post screw 21 may be used to secure the front 16 and back 18 to the first platform 28 and second platform 32.

Holders 60 may be mounted to the second platform 32. A holder is a pocket 62 defined by walls 64 and accessed by aperture 66. A suitable holder 60 should be transparent at least in part to provide visual access to the contents, e.g. collectable therein. A flap 68 may be joined to the pocket 62 via a hinge 70. The flap 68, pocket 62 and hinge 70 may be integral. The flap 68 preferably defines a plurality of apertures 72 through which fasteners 74 may extend.

The holder 60 is preferably the general size and shape of an envelope to fit first day covers. In such a configuration, the aperture 66 providing entrance into the pocket 62 should be positioned along a short edge and the flap 68 should be positioned along an adjacent long edge of the holder 60. This positioning allows the holder 60 to hang vertically below the fasteners 74, avoiding sagging of the holders 60 and ultimate bending of the collectable due to gravity when the album 10 is in an upright position or the album 10 is opened on the stand 50.

Medallions 80 or the like may be used to disclose information about the collectibles. Inner medallions 82 may include a center medallion 84, secured to the inside surface of the binding 20, identifies the collection as a whole; lateral medallions 86, when warranted may be secured to the second platform to identify portions of the collection, and holder medallions 88. Holder medallions 88 identify an individual collectable, such as a specific first day cover. The holder medallions 88 may be joined in conjunction with the flap 68 of the holder 60, providing a clamping force along the entire flap 68 to secure the holder to the second platform 32. The center medallion 84 is shown with a decorative ribbon.

Outer medallions 90 may include a cover medallion joined on the outside surface of the front 16 of the cover 12 to identify the collection or source thereof. Binding medallions, such as the upper 94, lower 96 and middle 98 may disclose the appropriate years and type or source of the collection.

Medallions 80 provide a decorative function, but more important to the collector is the disbursal of information. The further away the medallion 80 is located in reference to the collectable, the more general the information should be, while the medallions 80 adjacent the collectable may disclose very specific information. Medallions 80 may be used to secure the appropriate coating 24, 30 or 34 to the associated parts.

Ties 36 are used to secure and protect the collectibles when not being closely examined. Inner ties 38 are fastened between the first platform 28 and second platform 32, preferably in two portions as shown on the left half of FIG. 1. Clips 48 (FIG. 1) may be formed of metal, fastened to the second platform 32, and may be used to control wear of the second platform 32 caused by the ties 36. When the holders are positioned in a resting position as shown on the right half of FIG. 1, the inner ties 38 may be laid across the top of the holders 60 and secured via a selective fastener 42. This prevents the flopping of the collectibles thereby avoiding damage. Disconnecting the selective fastener 42 allows access to the collectable as shown on the left half of FIG. 1.

Cords 46 may be covered in a manner similar to the first and/or second platforms 28,32. Cords 46 may optionally be used to cover the joint between two or more components as has been described herein. A flap 44, shown in part in FIG. 1, may be a padded blanket-like foldable member, which would lie under the cords 46. The flap 44 folds up to uncover the holders 60 or down to protect the holders 60 from scratching the holders 60 of the opposing side of the album 10.

Outer ties 40 may be joined to the cover 12. The outer ties provide a mechanism for holding the album 10 closed during transport. Non-secure closures allow the collectibles to intermittently be exposed to external forces, which may cause damage to the collectibles. Ties 40 selectively join for closure of the album 10 and display of the contents thereof at the behest of the collector. Ribbons are found to be decorative yet provide the structural integrity important to the ties 36.

Although the present invention has been described with reference to preferred embodiments, workers skilled in the art will recognize changes may be made in form and detail without departing from the spirit and scope of the invention

1) An album, comprising:
a cover, the cover having a front and a back hingedly joined with a binding, the cover having an overlying coating; the cover being joined to corner protectors;
a first platform joined to an inner surface of the cover, the first platform having an overlying coating;
a second platform joined to the first platform, the second platform having an overlying coating;
holders secured to the second platform, the holders having a pocket hingedly joined to a flap, the pocket having walls defining an aperture, the flap defining apertures, fasteners extending through the apertures in the flap and securing to the second platform; and
medallions including holder medallions fastened to the second platform with the flap of the holders secured therebetween.

2) An album, comprising:
a cover, the cover having a front and a back hingedly joined with a binding, the cover having an overlying coating; the cover being joined to corner protectors; and
a first platform joined to an inner surface of the cover, the first platform having an overlying coating.

3) The device of claim 2 further comprising:
a second platform joined to the first platform, the second platform having an overlying coating.

4) The device of claim 3 further comprising:
inner ties secured between the first and second platforms, the inner ties being selectively attachable.

5) The device of claim 3 further comprising:
holders secured to the second platform.

6) The device of claim 5 wherein the holders further comprise:
a pocket hingedly joined to a flap, the pocket having walls defining an aperture, the flap defining apertures.

7) The device of claim 6 further comprising:
fasteners extending through the apertures in the flap and securing to the second platform.

8) The device of claim 2 further comprising:
inner ties secured to the first platform, the inner ties being selectively attachable.

9) The device of claim 2 further comprising:
outer ties secured to the cover, the outer ties being selectively attachable.

10) The device of claim 2 further comprising:
a stand supporting the cover.

11) The device of claim 2 further comprising:
medallions including an inner center medallion joined to an inner surface of the binding.

12) The device of claim 3 further comprising:
lateral medallions secured to the second platform.

13) The devices of claim 6 further comprising:
holder medallions fastened to the second platform with the flap of the holders secured therebetween.

14) The device of claim 2 further comprising:
an outer cover medallion secured to the front of the cover.

15) The device of claim 2 further comprising:
binding medallions secured to the outer surface of the binding.

16) An album, comprising:
a cover, the cover having a front and a back hingedly joined with a binding, the cover having an overlying coating; the cover being joined to corner protectors;
a first platform joined to an inner surface of the cover, the first platform having an overlying coating; and
a second platform joined to the first platform, the second platform having an overlying coating.

17) The device of claim 16 further comprising:
inner ties secured between the first and second platforms, the inner ties being selectively attachable.

18) The device of claim 16 further comprising:
a stand supporting the cover.

19) The device of claim 16 further comprising:
holders secured to the second platform, the holders having a pocket hingedly joined to a flap, the pocket having walls defining an aperture, the flap defining apertures, fasteners extending through the apertures in the flap and securing to the second platform.

20) The device of claim 19 further comprising:
holder medallions fastened to the second platform with the flap of the holders secured therebetween.
